(19) United States
(12) Patent Application Publication
(10) Pub. No.: US 2008/0048909 A1
(43) Pub. Date: Feb. 28, 2008

(54) Mobile object locating system

(76) Inventors: Alexander Ioffe, Bonn (DE); Carsten Hildebrand, Wuppertal (DE)

Correspondence Address: DELPHI TECHNOLOGIES, INC., M/C 480-410-202, PO BOX 5052, TROY, MI, 48007, US

(21) Appl. No.: 11/821,581

(22) Filed: Jun. 22, 2007

(30) Foreign Application Priority Data
Jul. 11, 2006 (EP) 06014374.0

(51) Int. Cl. G01S 5/00

(52) U.S. Cl. 342/357.07

(57) ABSTRACT

In a system for remotely locating a mobile object and in particular of a vehicle on the basis of a remote control system comprising a control device associated with the mobile object, an identification device on the user side, for example with an associated transceiver or with separate transmitter and receiver devices, a transceiver or separate transmitter and receiver devices associated with the mobile object, and at least one antenna arrangement associated with the mobile object for bidirectional wireless communication with the identification device, the reception and/or transmission characteristics of the antenna arrangement can be set such that a monitored zone results around this mobile object which, observed in the horizontal plane, extends over a fan angle of at least substantially 360°. Means for the detection of the respective spacing between the identification device and the mobile object and/or for the detection of a change in this spacing are provided. The identification device includes signaling and/or display means to signal and/or display at least the respective spacing between the identification device and the mobile object and/or the change in this spacing.

### TECHNICAL FIELD

The invention relates to a system for remotely locating a mobile object, such as in particular a vehicle. The vehicle can, for example, be a motor vehicle, a ship or a bicycle.

### BACKGROUND OF THE INVENTION

Remote control systems or access control systems for vehicles having a control device on the access side, an identification device on the user side and, for example, a transceiver or separate transmitter and receiver devices associated with the control device for bidirectional wireless communication with the identification device are known. An access control system of this type is used as a rule when it is a question of checking whether a respective person or a bearer of a respective identification device is authorized to pass the respective access control device. Theft of the vehicle should in particular be countered here with the respective access control devices.

A respective access control system can in particular be provided as a so-called keyless access system and/or as a keyless starting system (RKE=remote keyless entry) for vehicles. In this case, it includes an electronic control device associated with the vehicle and the portable identification devices which should identify a respective authorized user. In this connection, a respective identification device can itself be part of a vehicle key or key fob which is in bidirectional data exchange with the control device in the region of the locking and/or starting system of the vehicle. The respective identification devices can in particular also be integrated in chip cards or the like and can be made, for example, as transponders. Transponders of this type do not have their own energy supply; they are rather supplied with energy in a wireless manner when the identification device approaches the control device and are addressed automatically in the further process for the transmission of the authentication response signals. The RF antennas previously used in these known remote control systems or access control systems have fixed reception and transmission characteristics which additionally bring along clearly different ranges in the different directions around the vehicle.

### SUMMARY OF THE INVENTION

It is the underlying object of the invention to provide a location system of the initially named kind which is as effective and as reliable as possible. In this connection, use should be made as far as possible of the previously known remote control systems or access control systems.

These and other features and advantages of this invention will become apparent upon reading the following specification, which, along with the drawings, describes a preferred embodiment of the invention in detail.

### BRIEF DESCRIPTION OF THE DRAWINGS

The description herein makes reference to the accompanying drawings wherein like reference numerals refer to like parts throughout the views wherein:

FIG. 1, is a perspective, partially schematic view of a mobile object locating system embodying the present invention, in which the mobile object is a motor vehicle; and

FIG. 2, is a perspective, partially schematic view of the portable identification device of FIG. 1, with the device configured as a key fob.

### DESCRIPTION OF THE PREFERRED EMBODIMENT

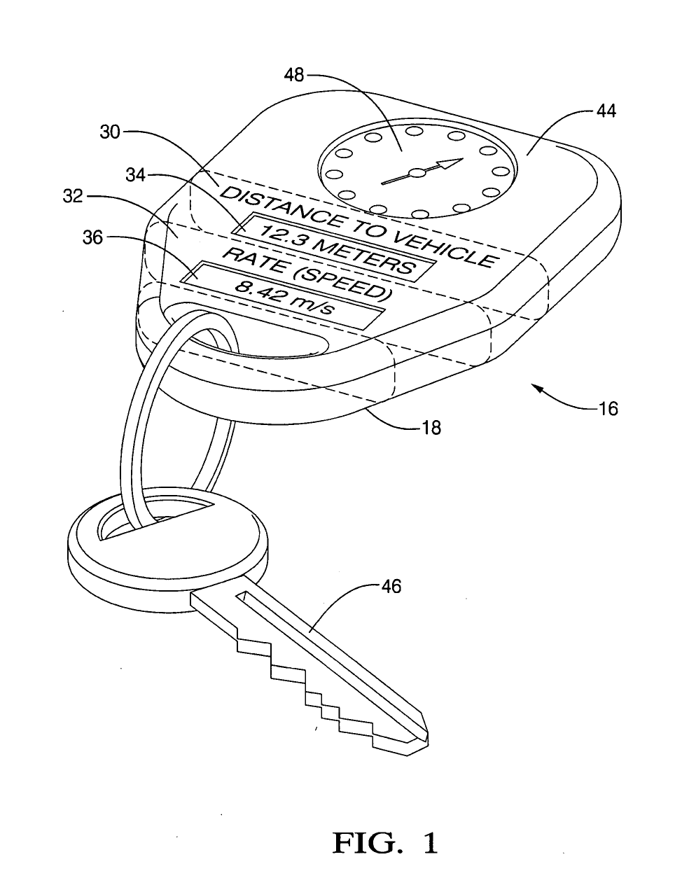

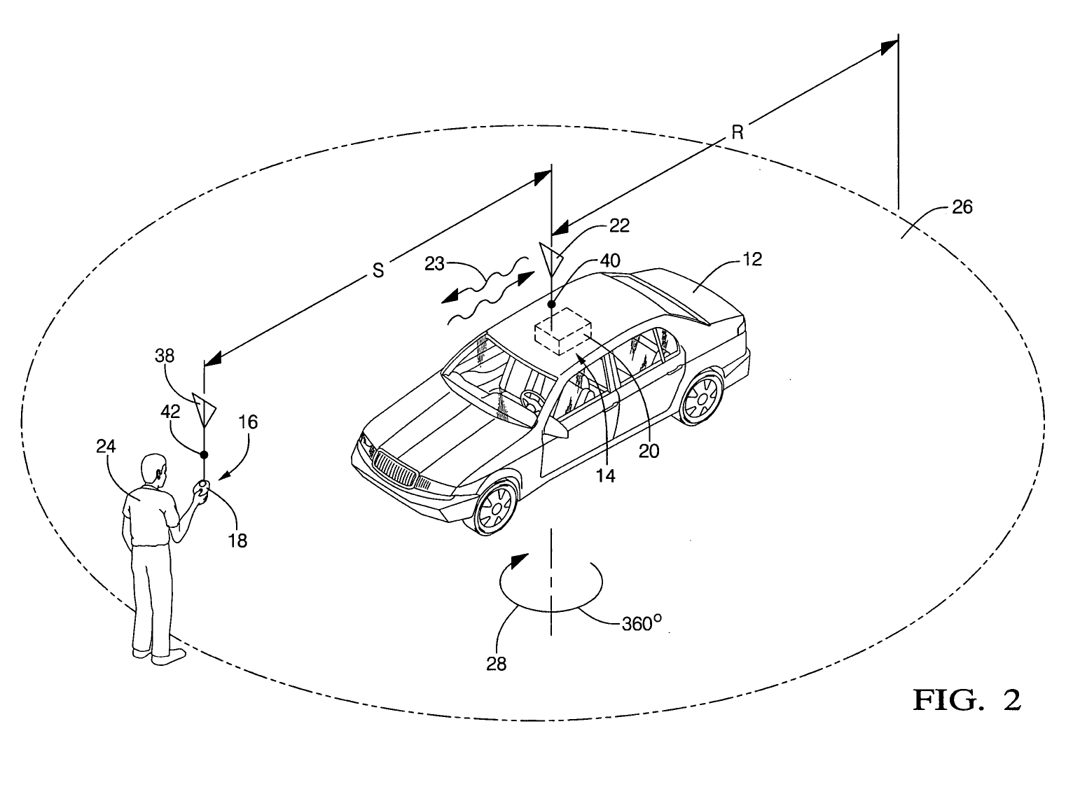

Referring to FIGS. 1 and 2, in accordance with the invention, the above-described object is satisfied by a system 10 for the location of a mobile object 12, such as in particular a vehicle, based on a remote control system 10 comprising a control device 14 associated with the mobile object 12, an identification device 16 on the user 24 side, for example with an associated transceiver 18 or with separate transmitter and receiver devices, a transceiver 20 or separate transmitter and receiver devices associated with the mobile object 12, and at least one antenna arrangement 22 associated with the mobile object 12 for bidirectional wireless communication 23 with the identification device 16, wherein the reception and/or transmission characteristics of the antenna arrangement 22 can be set such that a monitored zone 26 having maximum radius “R” results around this mobile object 12 which, observed in the horizontal plane, extends over a fan angle 28 of at least substantially 360°, wherein means 30 for the detection of the respective spacing between the identification device 16 and the mobile object 12 and/or means 32 for the detection of a change in this spacing are provided, and wherein the identification device 16 includes signaling and/or display means 34 and 36 to signal and/or display at least the respective spacing between the identification device and the mobile object and/or the change in this spacing.

The antenna arrangement 22 can in particular be a RF antenna arrangement.

By the further development in accordance with the invention of the previously known remote control or access control systems, a location system based on such a further developed remote control system is now created in accordance with the invention. This is in particular achieved in that the reception and/or transmission characteristics of the antenna arrangement can now be adjusted such that, unlike with the previously known remote control systems, a monitored zone 26 results around the mobile object, i.e. for example the vehicle, which extends, observed in the horizontal plane, over a fan angle 28 of at least substantially 360°. Only thereby are the conditions provided for a detection of the respective spacing or of a respective spacing change. In accordance with the invention, the means are provided for the detection of the respective spacing between the identification device 16 and the mobile object 12 and/or for the detection of a change in this distance “S”. The identification device includes signaling and/or display means to signal or display at least the respective spacing between the identification device and the mobile object and/or the change in this spacing. It is thus possible, for example, to guide a vehicle owner to his vehicle within the range of the bidirectional communication link of the remote control system.

At least the reception characteristics of the antenna arrangement can preferably be correspondingly adjusted such as with impedance matching device 42 on antenna 38 and 40 on antenna 22.

The respective reception and transmission characteristics of the antenna arrangement is advantageously adjustable via a corresponding control of the antenna arrangement and/or a corresponding evaluation of the received signals by the electronic control device.

In accordance with a preferred practical embodiment of the system in accordance with the invention, means 44 are additionally provided for the detection of the respective direction of the identification device with respect to the mobile object, with the respective direction moreover being able to be signaled or displayed via the signaling and display means associated with the identification device.

The means for the detection of the respective spacing or for the detection of a respective change in this spacing and/or the means for the detection of the respective direction are expediently associated with the control device on the vehicle side, for example, with the respective spacing information or direction information being transmitted from the mobile object to the identification device via the bidirectional communication link 23.

The range of the system is advantageously between approximately 0 m and approximately 700 m, in particular between 0 m and approximately 600 m and preferably between 0 m and approximately 500 m.

The reception and/or transmission characteristics of the antenna arrangement can advantageously be variably adjusted, with at least the reception characteristics again preferably being correspondingly variably adjustable.

In accordance with a preferred practical embodiment of the system in accordance with the invention, the reception and/or transmission characteristics are adjustable and variable such that direction-selective characteristics are generated in the manner of a directional antenna whose radiated beam is pivoted over the range of at least substantially 360°.

The detection of the spacing or of the change in spacing or the detection of the direction expediently takes place at least partly on the basis of information which originates from the identification device and was received from the mobile object via at least two different directional beams of the direction-selective characteristics of the antenna arrangement.

In accordance with a further advantageous embodiment, the detection of the direction takes place at least partly on the basis of the phase difference between the received signals of different elements of the antenna arrangement. Such a variant in particular presents itself in the use of a so-called “phased array” antenna or group antenna.

A compass 44 is preferably respectively associated with the mobile object and/or with the identification device. It is thus possible, for example, that the azimuth position of the mobile object relative to the identification device is estimated by the control device. This information can then be transmitted via the bidirectional communication link to the identification device which can then correspondingly signal and/or display 48 the direction of the mobile object using the information from its own compass. This process can be repeated until the user has located the mobile object or his vehicle.

In a simplified cost-effective embodiment, the reception and/or transmission characteristics of the antenna arrangement can be set such that, unlike with the pivoting of a directional beam, they always cover the monitored zone extending at least substantially over 360° as a whole, with only the respective spacing or the respective change in spacing being detected.

It is also in particular of advantage for the system to be able to be switched between a mode serving for the detection of the spacing or of the change in spacing and, optionally, of the direction and a normal mode serving for the remote control. In this context, in response to the reception of a switch signal originating from the identification device, the reception mode of the mobile object or its reception characteristics can be correspondingly switched. The detection of the spacing or of the change in spacing and, optionally, of the direction, advantageously takes place by the control device on the basis of the signals received from the identification device after the switching.

The identification device can in particular be integrated in a key fob with key 46 or the like. As already mentioned, such an identification device can, however, also be part of the vehicle key or be integrated in a chip card or the like.

The mobile object can, as already mentioned, in particular be a vehicle, for example a motor vehicle, a ship, a bicycle or the like.

The remote control system or access control system used can still also satisfy the previously customary remote control or access control functions. For the location function in accordance with the invention, it is then possible, for example, to switch from this mode relating to the normal operation to the location mode. To the extent that a so-called “directional beam” is spoken of here, it can be generated, for example, both by a corresponding bundling of the radiation and by a corresponding calculation in the control device so that an “imaginary” directional beam is meant at least in the latter case. The term “remote control system” should here also cover all access control systems in general.

The underlying remote control system can still also satisfy the previously customary safety regulations. It can thus, for example, still be made such that access is no longer possible outside a predetermined near zone.

The detection of the direction can in particular be based on the Doppler effect.

Further features and advantages of the invention result from the following embodiments.

In accordance with the invention, the previously existing RF antennas were further developed for keyless motor vehicle remote control systems or access control systems for an additional location function.

The location system in accordance with the invention is based on a keyless remote control system or access control system (RKE=remote keyless entry) comprising an identification device integrated, for example, in a key fob and a transceiver provided in the vehicle, between which bidirectional communication takes place. The vehicle location system guides the vehicle owner to the vehicle inside the range of the bidirectional remote control system. To realize a reliable location system, the reception characteristics were correspondingly adapted and improved and a further function was realized which in particular makes it possible to generate so-called directional beam characteristics of the RF antenna associated with the vehicle. This special directional antenna should have all the properties required for the vehicle location system. For instance, the range can, for example, be correspondingly extended in comparison with the previously provided antenna integrated, for example, on printed circuit boards (PCB). A more accurate determination of the direction of the identification device with respect to the vehicle is possible using the direction-selective characteristics. An at least substantially circular field should at least be generated around the vehicle. The previously used antennas lack circular reception characteristics so that a location function is not yet possible with them. For instance, with these previously customary antennas, neither the spacing between the owner and the vehicle nor the direction of the identification device with respect to the vehicle can be determined.

For the previous remote control function (RKE=remote keyless entry), the conventional RF antennas had non-circular characteristics with a very different communication range around the vehicle, which means that the guaranteed communication range is very limited.

In accordance with the invention, a flexible RF antenna system is now used, for example, instead of the previously customary fixed antenna on the printed circuit. One possibility consists of using an antenna array having different inputs and using different phases of the inputs to generate different radiation patterns. Another possibility consists of controlling the elements of such an antenna array sequentially. Such a system has two target directions. Since different antenna characteristics are used, the integrated radiation pattern can be made at least substantially circular, whereby the guaranteed range of the remote control (RKE) communication is increased. On the other hand, the information with respect to the spacing from the identification device is obtained by a combination of the information from the identification device which was received via the different actual or imaginary so-called “directional beams” of the antenna, with moreover the directional angle being able to be estimated at least approximately. “Directional beams” are here to be understood, for example, as antenna radiation patterns which differ clearly from one another and which preferably face in one or a few azimuth directions. A further possibility consists of realizing the direction difference by calculation on the basis of the phase difference between the signals of the identification device received by the different elements of the antenna system.

The vehicle location system can detect the direction of the identification device with respect to the position of the vehicle using such an antenna arrangement. As a result of the improved azimuth radiation pattern, the spacing of the identification device from the vehicle can also be determined.

A vehicle location system, i.e. a system for the locating of the vehicle, can be realized with these two properties of the receiving antenna.

In the first case, a compass is provided as the respectively only additional component in the identification device and in the mobile object or vehicle. In this connection, a respective function on the side of the vehicle can be triggered via the identification device in that, for example, a specific search RKE query is transmitted for the vehicle which causes the vehicle receiver unit to switch from a normal reception mode for the remote control function or access control function into a so-called “directional beam” mode in which the direction of the signals subsequent thereto transmitted by the identification device to be located is analyzed.

In conjunction with the information from the compass in the vehicle, the vehicle system can estimate the global azimuth position of the vehicle relative to the identification device. The respective information is then transmitted to the identification device which can, for example, display the direction toward the vehicle using the information from its own compass. This procedure can be repeated until the owner has found his vehicle. The direction can be displayed, for example, using an illuminated compass symbol or in a simple manner via a more comfortable display.

The following simple, cost-effective embodiment is also feasible, for example, in which an additional search mode of the vehicle system and the respective compass on the side of the vehicle and of the identification device can be dispensed with. It is not necessary with this embodiment that the vehicle antenna provides different “directional beams”. The “directional beam” feature is reduced to covering a more or less circular region by the antenna system. In this case, only the spacing from the identification device is determined by the vehicle system. For this purpose, for example, the RSSI value or the strength of the received signal can be measured by the identification device (RSSI=received signal strength indicator). A further possibility consists of modulating the RF carrier frequency of the vehicle signal on the basis of amplitude modulation using an LF signal, e.g. 125 kHz, and of estimating the spacing on the basis of the phase of the incoming signal amplitude modulation in comparison with the simultaneously triggered LF oscillation in the identification device. The RSSI measurement and the path measurement can be combined with one another in any case.

In this simple, cost-effective embodiment, the user receives information on whether the spacing from the vehicle increases or decreases when he moves. For this purpose, an LED display can, for example, be provided, with a color change, e.g. from red to green, being able to be generated in dependence on the spacing. An acoustic signaling is, however, also conceivable, for example. In this connection, the volume can be varied in dependence on the spacing, for example. Means can, for example, also be provided for the generation of knocking signals (sounders), with in this case, for example, the repetition frequency of the knocking signals being able to be varied in dependence on the spacing.

In the case of a keyless remote control system or access control system based on LF trailing antennas of the technology of flexible printed circuits (FPCs), the directional antenna can be realized, for example, on the same flexible printed circuit to reduce costs.

Relative transmitter/receiver signal strength can be adjusted or controlled by impedance matching of the antennas 22 and 38 with transceivers 14 and 16, respectively with known controller “ΔZ” devices 40 and 42.

1. A system for the location of a mobile object such as a vehicle employing a remote control system comprising: a control device associated with the mobile object; an identification device on the user side, for example with an associated transceiver or with separate transmitter and receiver devices; transceiver or separate transmitter and receiver devices associated with the mobile object; and at least one antenna arrangement associated with the mobile object for bidirectional wireless communication with the identification device, wherein the reception and/or transmission characteristics of the antenna arrangement can be set such that a monitored zone results around this mobile object which, observed in the horizontal plane, extends over a fan angle of at least substantially 360°, wherein means for the detection of the respective spacing between the identification device and the mobile object and/or for the detection of a change in this spacing are provided, and wherein the identification device includes signaling and/or display means to signal and/or display at least the respective spacing between the identification device and the mobile object and/or the change in this spacing.

2. A system in accordance with claim 1, wherein the reception characteristics of the antenna arrangement can be correspondingly adjusted.

3. A system in accordance with claim 1, wherein the respective reception and transmission characteristics of the antenna arrangement can be adjusted via a corresponding control of the antenna arrangement and/or via a corresponding evaluation of the received signals by the control device.

4. A system in accordance with claim 1, further comprising means for detecting the respective direction of the identification device relative to the mobile object and moreover the respective direction can be signaled or displayed via the signaling and display means associated with the identification device.

5. A system in accordance with claim 1, wherein the means for the detection of the respective spacing or for the detection of a respective change in this spacing and/or the means for the detection of the respective direction are associated with the control device and the respective spacing information or directional information is transmitted via the bidirectional communication link to the identification device.

6. A system in accordance with claim 1, wherein said system has a detection range of between approximately 0 m and approximately 700 m, in particular between 0 m and approximately 600 m and preferably between 0 m and approximately 500 m.

7. A system in accordance claim 1, wherein the reception and/or transmission characteristics of the antenna arrangement are variably adjustable.

8. A system in accordance with claim 7, wherein the reception and transmission characteristics of the antenna arrangement are adjustable and variable such that direction-selective characteristics are generated in the manner of a directional antenna whose directional beam is pivoted over the range of at least substantially 360°.

9. A system in accordance with claim 1, wherein the detection of the spacing or of the change in spacing or the detection of the direction takes place at least partly on the basis of information which originate from the identification device and were received from the mobile object via at least two different directional beams of the direction-selective characteristics of the RF antenna arrangement.

10. A system in accordance with claim 1, wherein the detection of the direction takes place at least partly on the basis of the phase difference between the received signals of different elements of the antenna arrangement.

11. A system in accordance with any claim 1, further comprising a compass associated with the mobile object and/or with the identification device respectively.

12. A system in accordance with claim 1, wherein the reception and/or transmission characteristics of the RF radio arrangement can be adjusted such that, unlike with the pivoting of a directional beam, it always covers the monitored zone extending at least substantially over 360° in full; and in that only the respective spacing or the respective change in spacing is detected.

13. A system in accordance with claim 1, wherein said system can be switched between a mode serving for the detection of the spacing or of the change in spacing and, optionally, of the direction, and a normal mode serving for the remote operation.

14. A system in accordance with claim 13, wherein in response to the reception of a switch signal originating from the identification device, the reception mode of the mobile object or its reception characteristics can be switched accordingly.

15. A system in accordance with claim 12, wherein detection of the spacing or of the change in spacing and, optionally, of the direction, by the control device advantageously takes place on the basis of the signals received from the identification device after the switching.

16. A system in accordance with claim 1, wherein the identification device is integrated in a key fob.

17. A system in accordance with claim 1, wherein the antenna arrangement is formed by an RF antenna arrangement.
